(19) United States
(12) Patent Application Publication
(10) Pub. No.: US 2013/0237624 A1
(43) Pub. Date: Sep. 12, 2013

(54) METHOD FOR PRODUCING FLEXIBLE POLYURETHANE FOAMS

(71) Applicants: Bert Klesczewski, Koeln (DE); Gundolf Jacobs, Roesrath (DE); Sven Meyer-Ahrens, Leverkusen (DE); Hartmut Nefzger, Pulheim (DE)

(72) Inventors: Bert Klesczewski, Koeln (DE); Gundolf Jacobs, Roesrath (DE); Sven Meyer-Ahrens, Leverkusen (DE); Hartmut Nefzger, Pulheim (DE)

(73) Assignee: BAYER INTELLECTUAL PROPERTY GMBH, Monheim (DE)

(21) Appl. No.: 13/880,331

(22) PCT Filed: Nov. 18, 2011
(86) PCT No.: PCT/EP2011/070478

§ 371 Date: Apr. 18, 2013

(30) Foreign Application Priority Data
Nov. 22, 2010 (EP) 10192092.4

(51) Int. Cl. C08J 9/12

(52) U.S. Cl. CPC C08J 9/125
USPC 521/173

(57) ABSTRACT

The present invention relates to a method for producing flexible polyurethane foams, wherein a polyol component which comprises polyricinoleic acid esters is used as starting substance. The flexible polyurethane foams according to the invention have a bulk density according to DIN EN ISO 3386-1-98 in the range of ≧10 kg/m³ to ≦150 kg/m³, preferably ≧20 kg/m³ to ≦70 kg/m³, and in general their compressive strength according to DIN EN ISO 3386-1-98 is in the range of ≧0.5 kPa to ≦20 kPa (at 40% deformation and 4th cycle). The polyricinoleic acid esters are obtainable by the reaction of ricinoleic acid with an alcohol component which comprises mono- and/or polyhydric alcohols with a molecular mass of ≧32 g/mol to ≦400 g/mol, the reaction being carried out at least in part in the presence of a catalyst.

The present invention relates to a method for producing flexible polyurethane foams, wherein a polyol component (component A) which comprises polyricinoleic acid esters is used as starting substance. The flexible polyurethane foams according to the invention have a bulk density according to DIN EN ISO 3386-1-98 in the range of ≧10 kg/m³ to ≦150 kg/m³, preferably ≧20 kg/m³ to ≦70 kg/m³, and in general their compressive strength according to DIN EN ISO 3386-1-98 is in the range of ≧0.5 kPa to ≦20 kPa (at 40% deformation and 4th cycle). The polyricinoleic acid esters are obtainable by the reaction of ricinoleic acid with an alcohol component which comprises mono- and/or polyhydric alcohols with a molecular mass of ≧32 g/mol to ≦400 g/mol, the reaction being carried out at least in part in the presence of a catalyst.

Polyricinoleic acid esters are obtained industrially by polycondensation of monomeric ricinoleic acid and an alcohol component. This reaction takes place slowly in comparison with the esterification of e.g. adipic acid and di-primary hydroxyl components and is therefore disadvantageous. To compensate for the substance-related lower functionality of hydroxyl groups, during synthesis of the polyricinoleic acid esters a low molecular weight polyol can be added as a further component, in order to ensure the ultimate excess of hydroxyl over carboxyl groups.

At present, during the synthesis of a polyricinolate from ricinoleic acid and a low molecular weight polyol on an industrial scale, vessel retention times of in some cases more than 80 hours are required in order to obtain a product with an acid value of less than 5 mg KOH/g and a hydroxyl value in the range of 30 to 80 mg KOH/g. A production of polyricinoleic acid esters is described e.g. in EP 0 180 749 A1. This patent application relates to a method for producing optionally microcellular, elastomeric mouldings having self-supporting properties. Here, in closed moulds, a reaction mixture of organic polyisocyanates and solutions of chain extenders in a molecular weight range of 62 to 400 is converted to higher molecular weight polyhydroxy compounds in a molecular weight range of 1800 to 12000 with the assistance of catalysts, internal mould release agents and optionally further auxiliary substances and additives. Internal mould release agents mentioned here are condensation products in a molecular weight range of 900 to 4500 having ester groups, an acid value of less than 5 mg KOH/g and a hydroxyl value of 12.5 to 125 mg KOH/g comprising 3 to 15 moles of ricinoleic acid and one mole of a mono- or polyhydric alcohol in a molecular weight range of 32 to 400 or a total of one mole of a mixture of several such alcohols.

It was the object of the present invention to provide a method for producing flexible polyurethane foams, wherein the polyol component comprises a polyether polyol based on sustainable raw materials. For ecological reasons, it would be advantageous if, starting from a polyol component based on conventional polyether polyol, up to 50 parts by weight of the polyether polyol can be substituted by polyether polyol based on sustainable raw materials without the formulation for the production of the flexible polyurethane foam having to be adapted in order to achieve comparable processability. In addition, the foams produced therefrom should be comparable with conventional foams in terms of their compressive strength and tensile properties.

Surprisingly, it has been found that the above-mentioned object is achieved by a method for producing flexible polyurethane foams with a bulk density according to DIN EN ISO 3386-1-98 in the range of ≧10 kg/m³ to ≦150 kg/m³, preferably ≧20 kg/m³ to ≦70 kg/m³, and a compressive strength according to DIN EN ISO 3386-1-98 in the range of ≧0.5 kPa to ≦20 kPa (at 40% deformation and 4th cycle) by reaction of

Component A (polyol formulation) comprising
A1 50 to 95 parts by weight, preferably 50 to 80 parts by weight (based on the sum of the parts by weight of components A1 and A2) of conventional polyether polyol,
A2 5 to 50 parts by weight, preferably 20 to 50 parts by weight (based on the sum of the parts by weight of components A1 and A2) of polyricinoleic acid ester with a hydroxyl value of 30 mg KOH/g to 80 mg KOH/g and an acid value of less than 5 mg KOH/g,
A3 0.5 to 25 parts by weight, preferably 2 to 5 parts by weight (based on the sum of the parts by weight of components A1 and A2) of water and/or physical blowing agents,
A4 0.05 to 10 parts by weight, preferably 0.2 to 4 parts by weight (based on the sum of the parts by weight of components A1 and A2) of auxiliary substances and additives, such as
   a) catalysts,
   b) surface-active additives,
   c) pigments or flame retardants,
   A5 0 to 10 parts by weight, preferably 0 to 5 parts by weight (based on the sum of the parts by weight of components A1 and A2) of compounds having hydrogen atoms capable of reacting with isocyanates having a molecular weight of 62-399,
      with component B comprising polyisocyanates,
      wherein the production takes place at an index of 50 to 250, preferably 70 to 130, particularly preferably 75 to 115, and
      wherein all data relating to parts by weight of components A1 to A5 in the present application are standardised so that the sum of the parts by weight of components A1+A2 in the composition is 100.

### Component A 1

Starting components according to component A1 are conventional polyether polyols. The term conventional polyether polyols within the meaning of the invention refers to compounds which are alkylene oxide addition products of starter compounds with Zerewitinoff active hydrogen atoms, i.e. polyether polyols with a hydroxyl value according to DIN 53240 of ≧15 mg KOH/g to ≦80 mg KOH/g and preferably ≧20 mg KOH/g to ≦60 mg KOH/g.

Starter compounds with Zerewitinoff active hydrogen atoms used for the conventional polyether polyols generally have functionalities of 2 to 6, preferably 3, and the starter compounds are preferably hydroxyfunctional. Examples of hydroxyfunctional starter compounds are propylene glycol, ethylene glycol, diethylene glycol, dipropylene glycol, 1,2-butanediol, 1,3-butanediol, 1,4-butanediol, hexanediol, pentanediol, 3-methyl-1,5-pentanediol, 1,12-dodecanediol, glycerol, trimethylolpropane, triethanolamine, pentaerythritol, sorbitol, sucrose, hydroquinone, pyrocatechol, resorcinol, bisphenol F, bisphenol A, 1,3,5-trihydroxybenzene and condensates of formaldehyde and phenol or melamine or urea comprising methylol groups. Preferably, glycerol and/or trimethylolpropane is used as starter compound.

Suitable alkylene oxides are e.g. ethylene oxide, propylene oxide, 1,2-butylene oxide or 2,3-butylene oxide and styrene oxide. Propylene oxide and ethylene oxide are preferably added to the reaction mixture individually, in a mixture or consecutively. If the alkylene oxides are metered in consecutively, the products produced comprise polyether chains with block structures. Products with ethylene oxide end blocks are characterised e.g. by elevated concentrations of primary end groups, which give the systems an advantageous isocyanate reactivity.

### Component A2

The polyricinoleic acid esters used are obtained by polycondensation of ricinoleic acid and mono- or polyhydric alcohols, the polycondensation preferably taking place in the presence of a catalyst. In the method for the production of the polyricinoleic acid esters, the quantity of catalyst, based on the total mass of ricinoleic acid and alcohol component, are e.g. in a range of ≧10 ppm to ≦100 ppm. The polyricinoleic acid esters used have an acid value of less than 5 mg KOH/g and preferably of less than 4 mg KOH/g. This can be achieved by terminating the polycondensation when the acid value of the reaction product obtained is less than 5 mg KOH/g and preferably less than 4 mg KOH/g.

Suitable mono- or polyhydric alcohols can be, without being restricted thereto, alkanols, cycloalkanols and/or polyether alcohols. Examples are n-hexanol, n-dodecanol, n-octadecanol, cyclohexanol, 1,4-dihydroxycyclohexane, 1,3-propanediol, 2-methyl-1,3-propanediol, 1,5-pentanediol, 1,6-hexanediol, 1,8-octanediol, neopentyl glycol, diethylene glycol, triethylene glycol, tetraethylene glycol, dipropylene glycol, tripropylene glycol, dibutylene glycol, tripropylene glycol, glycerol and/or trimethylolpropane. Preferred here are 1,3-propanediol, 1,5-pentanediol, 1,6-hexanediol, neopentyl glycol, diethylene glycol, triethylene glycol and/or trimethylolpropane. The above alcohols have boiling points at which removal together with water of reaction can be avoided and therefore do not have a tendency towards undesirable side reactions at conventional reaction temperatures.

Suitable catalysts or catalyst precursors can be Lewis or Brønstedt acids such as e.g. sulfuric acid, p-toluenesulfonic acid, tin(II) salts or titanium(IV) compounds, such as titanium tetrabutylate or titanium(IV) alcoholates.

To calculate the catalyst content, in the case of Brønstedt acids the neutral compound is used as the starting point. With sulfuric acid, for example, the H₂SO₄ molecule is taken as the basis. If the catalyst is a Lewis acid, the catalytically active cationic species is used. For example, in the case of tin(II) salts, irrespective of the particular counterion, only the Sn²⁺ cation or, in the case of titanium(IV) compounds, only the Ti⁴⁺ cation would be taken into account. This approach is advantageous, since the content of metallic species can be determined by means of atom absorption spectroscopy (AAS) without having to know the particular counterion.

The proportion of catalyst, based on the total mass of ricinoleic acid and alcohol component, can also lie within a range of ≧20 ppm to ≦80 ppm, preferably ≧40 ppm to ≦60 ppm.

The reaction can be carried out at reduced pressure and elevated temperature with simultaneous distillation of the water formed during the condensation reaction. Likewise, it can take place by the azeotrope method in the presence of an organic solvent such as toluene as entrainer or by the carrier gas method, i.e. by driving off the water formed with an inert gas such as nitrogen or carbon dioxide.

The reaction is terminated when the acid value of the reaction product obtained is less than 5 mg KOH/g, preferably less than 4 mg KOH/g. This value can be determined in accordance with DIN 53402 and established during the reaction e.g. by taking samples. The termination of the reaction can take place in the simplest case by cooling the reaction mixture, e.g. to a temperature of <50° C.

The molar ratio of ricinoleic acid and the alcohol component is preferably in a range of ≧3:1 to ≦10:1. Particularly preferably, this ratio is ≧4:1 to ≦8:1 and more preferably ≧5:1 to ≦7:1.

Surprisingly, it has been found that the polyricinoleic acid esters can be incorporated into flexible polyurethane foam formulations to a particular extent without having to make fundamental changes to the formulations, which did not comprise a constituent according to component A2, by the joint use of component A2 (polyricinoleic acid ester), i.e. the processability and the quality of the resulting flexible polyurethane foams are at a comparable level.

The method preferably comprises tin(II) salts as catalyst. Particularly preferred here is tin(II) chloride. It has been shown that tin(II) salts do not cause any problems in a subsequent reaction of the polyricinoleic acid ester to form polyurethanes or can also be used advantageously as a catalyst in this subsequent reaction.

The reaction temperature during the polycondensation is preferably ≧150° C. to ≦250° C. The temperature can also lie within a range of ≧180° C. to ≦230° C. and more preferably ≧190° C. to ≦210° C. These temperature ranges represent a good balance between the desired rate of reaction and possible undesirable side reactions, such as e.g. water elimination at the OH group of ricinoleic acid.

In a preferred embodiment of the method, ricinoleic acid and the alcohol component are initially reacted without catalyst. The catalyst is then added when the water formation reaction has come to a stop. The reaction is then continued with catalysis. The fact that the reaction initially runs without catalyst means that no additional external catalyst is used. This does not affect catalysis by the constituents of the reaction mixture of ricinoleic acid and mono- or polyhydric alcohols themselves. The invention thus also provides a method for the production of the flexible polyurethane foams according to the invention, wherein the polyricinoleic acid ester is obtainable by polycondensation of ricinoleic acid and the alcohol component without catalyst at a temperature of ≧150° C. to ≦250° C. until the water formation reaction has come to a stop, subsequent addition of the catalyst and further polycondensation at a temperature of ≧150° C. to ≦250° C. and distilling off the water formed until the acid value of the reaction mixture (polyricinoleic acid ester) is less than 5 mg KOH/g and preferably less than 4 mg KOH/g.

The water formation is considered as having come to a stop when, according to optical inspection of the reaction, no more water is distilled off or when more than 95% of the theoretical quantity of water has been removed from the reaction. This can be determined e.g. by an appropriately equipped distillation receiver, a Dean-Stark apparatus or by monitoring the weight of the distillate formed. To determine the end of the water formation, it is also possible e.g. to monitor the absorption behaviour of COOH and/or OH groups in the NIR range by spectroscopy. The reaction can then be completed up to previously established absorption values.

The fact that the reaction is continued with catalysis after addition of the catalyst means in this context catalysis by added external catalyst. According to this embodiment, a catalyst which is susceptible to hydrolysis, for instance titanium(IV) alcoholate, can be used at a later point in time when at least the majority of the water of reaction has already been separated off. This has no negative effect on the reaction period, since the esterification reaction is self-catalysed in the initial stage by the free COOH groups of the ricinoleic acid units and catalyst is only introduced when the reaction mixture begins to be depleted in COOH groups.

To calculate the catalyst content in the in the case of Brønstedt acids the neutral compound is used as the starting point. With sulfuric acid, for example, the H₂SO₄ molecule is taken as the basis. If the catalyst is a Lewis acid, the catalytically active cationic species is used. For example, in the case of tin(II) salts, irrespective of the particular counterion, only the Sn²⁺ cation or, in the case of titanium(IV) compounds, only the Ti⁴⁺ cation would be taken into account. This approach is advantageous, since the content of metallic species can be determined by means of atom absorption spectroscopy (AAS) without having to know the particular counterion. The polyricinoleic acid esters used as component A2 generally have a catalyst content of ≧20 ppm to ≦80 ppm. The content can also lie within a range of ≧40 ppm to ≦60 ppm.

### Component A3

As component A3, water and/or physical blowing agents are used. As physical blowing agents, e.g. carbon dioxide and/or highly volatile organic substances are used as blowing agents.

### Component A4

As component A4, auxiliary substances and additives are used, such as
a) catalysts (activators),
b) surface-active additives (surfactants), such as emulsifiers and foam stabilisers, in particular those with low emission such as e.g. products from the Tegostab® LF series,
c) additives such as retarders (e.g. acidic substances such as hydrochloric acid or organic acid halides), cell regulators (such as e.g. paraffins or fatty alcohols or dimethyl polysiloxanes), pigments, dyes, flame retardants (such as e.g. tricresyl phosphate), stabilisers against ageing and weathering influences, plasticisers, substances having fungistatic and bacteriostatic action, fillers (such as e.g. barium sulfate, kieselguhr, carbon black or precipitated chalk) and mould release agents.

These optionally incorporated auxiliary substances and additives are described e.g. in EP-A 0 000 389, pages 18-21. Further examples of optionally incorporated auxiliary substances and additives according to the invention and details of the use and mode of action of these auxiliary substances and additives are described in Kunststoff-Handbuch, volume VII, edited by G. Oertel, Carl-Hanser-Verlag, Munich, 3rd edition, 1993, e.g. on pages 104-127.

Preferred as catalysts are aliphatic tertiary amines (e.g. trimethylamine, tetramethyl butanediamine), cycloaliphatic tertiary amines (e.g. 1,4-diaza[2.2.2]bicyclooctane), aliphatic amino ethers (e.g. dimethylaminoethyl ether and N,N,N-trimethyl-N-hydroxyethyl bisaminoethyl ether), cycloaliphatic amino ethers (e.g. N-ethyl-morpholine), aliphatic amidines, cycloaliphatic amidines, urea, derivatives of urea (such as e.g. aminoalkyl ureas, cf. e.g. EP-A 0 176 013, in particular (3-dimethylaminopropylamine) urea) and tin catalysts (such as e.g. dibutyltin oxide, dibutyltin dilaurate, tin octoate).

Particularly preferred as catalysts are
α) urea, derivatives of urea and/or
β) amines and amino ethers, which each comprise a functional group that reacts chemically with isocyanate. The functional group is preferably a hydroxyl group or a primary or secondary amino group. These particularly preferred catalysts have the advantage that they exhibit a markedly reduced migration and emission behaviour.

The following may be mentioned as examples of particularly preferred catalysts: (3-dimethylaminopropylamine) urea, 2-(2-dimethylaminoethoxy)ethanol, N,N-bis(3-dimethylaminopropyl)-N-isopropanolamine, N,N,N-trimethyl-N-hydroxyethyl bis-aminoethyl ether and 3-dimethylaminopropylamine

### Component A5

As component A5, compounds with at least two hydrogen atoms capable of reacting with isocyanates and a molecular weight of 32 to 399 are optionally used. These are understood to mean compounds having hydroxyl groups and/or amino groups and/or thiol groups and/or carboxyl groups, preferably compounds having hydroxyl groups and/or amino groups, which act as chain extenders or crosslinking agents. These compounds generally have 2 to 8, preferably 2 to 4, hydrogen atoms capable of reacting with isocyanates. For example, ethanolamine, diethanolamine, triethanolamine, sorbitol and/or glycerol can be used as component A5. Further examples of compounds according to component A5 are described in EP-A 0 007 502, pages 16-17.

### Component B

Suitable polyisocyanates are aliphatic, cycloaliphatic, araliphatic, aromatic and heterocyclic polyisocyanates, as described e.g. by W. Siefken in Justus Liebigs Annalen der Chemie, 562, pages 75 to 136, e.g. those of formula (I)

Q(NCO)ₙ, (I)

in which
n=2-4, preferably 2-3,
and
Q represents an aliphatic hydrocarbon residue with 2-18, preferably 6-10 C atoms, a cycloaliphatic hydrocarbon residue with 4-15, preferably 6-13 C atoms or an araliphatic hydrocarbon residue with 8-15, preferably 8-13 C atoms.

For example, these are polyisocyanates as described in EP-A 0 007 502, pages 7-8. Generally preferred are the polyisocyanates that are readily accessible industrially, e.g. 2,4- and 2,6-toluene diisocyanate and any mixtures of these isomers (“TDI”); polyphenyl polymethylene polyisocyanates, as produced by aniline-formaldehyde condensation and subsequent phosgenation (“crude MDI”) and polyisocyanates having carbodiimide groups, urethane groups, allophanate groups, isocyanurate groups, urea groups or biuret groups (“modified polyisocyanates”), in particular those modified polyisocyanates that are derived from 2,4- and/or 2,6-toluene diisocyanate or from 4,4′- and/or 2,4′-diphenylmethane diisocyanate. Preferably, at least one compound selected from the group consisting of 2,4- and 2,6-toluene diisocyanate, 4,4′- and 2,4′- and 2,2′-diphenylmethane diisocyanate and polyphenyl polymethylene polyisocyanate (“polynuclear MDI”) is used as polyisocyanate, and a mixture comprising 4,4′-diphenylmethane diisocyanate, 2,4′-diphenylmethane diisocyanate and polyphenyl polymethylene polyisocyanate is particularly preferably used as polyisocyanate.

To produce the flexible polyurethane foams, the reaction components are reacted by the one-step method which is known per se, wherein mechanical devices are often used, e.g. those described in EP-A 355 000. Details of processing devices which are also suitable according to the invention are described in Kunststoff-Handbuch, volume VII, edited by Vieweg and Höchtlen, Carl-HanserVerlag, Munich 1993, e.g. on pages 139 to 265.

The flexible polyurethane foams can be produced as either moulded or slabstock foams. The invention therefore provides a method for the production of flexible polyurethane foams, the flexible polyurethane foams produced by this method, the flexible polyurethane slabstock foams or flexible polyurethane moulded foams produced by this method, the use of the flexible polyurethane foams for the production of mouldings and the mouldings themselves. The flexible polyurethane foams obtainable according to the invention have e.g. the following uses: furniture upholstery, textile inserts, mattresses, car seats, head supports, arm rests, sponges and structural elements.

The index represents the percentage ratio of the quantity of isocyanate actually used to the stoichiometric quantity, i.e. the quantity of isocyanate groups (NCO) calculated for the reaction of the OH equivalents.

Index=[(isocyanate quantity used):(isocyanate quantity calculated)]·100 (II)

Flexible polyurethane foams within the meaning of the present invention are those polyurethane polymers of which the bulk density according to DIN EN ISO 3386-1-98 is in the range of ≧10 kg/m³ to ≦150 kg/m³, preferably in the range of ≧20 kg/m³ to ≦70 kg/m³ and the compressive strength according to DIN EN ISO 3386-1-98 is in the range of ≧0.5 kPa to ≦20 kPa (at 40% deformation and 4th cycle).

### EXAMPLES

The present invention is explained further on the basis of the following examples. The materials and abbreviations used here have the following meaning and sources: Ricinoleic acid: Oleo Chemie.
Tin(II) chloride: Aldrich
DABCO® (triethylenediamine; 2,2,2-diazabicyclooctane): Aldrich
MDI-1: mixture comprising 62 wt. % 4,4′-diphenylmethane diisocyanate, 8 wt. % 2,4′-diphenylmethane diisocyanate and 30 wt. % polyphenyl polymethylene polyisocyanate (“polynuclear MDI”) with an NCO content of 32.1 wt. %.
MDI-2 mixture comprising 57 wt. % 4,4′-diphenylmethane diisocyanate, 25 wt. % 2,4′-diphenylmethane diisocyanate and 18 wt. % polyphenyl polymethylene polyisocyanate (“polynuclear-MDI”) with an NCO content of 32.5 wt. %.
A1-1: polyether polyol with an OH value of approx. 28 mg KOH/g, produced by addition of propylene oxide and ethylene oxide in a ratio of 85 to 15 using glycerol as starter with approx. 85 mole % primary OH groups.
A1-2: polyether polyol with an OH value of approx. 37 mg KOH/g, produced by addition of propylene oxide and ethylene oxide in a ratio of 27 to 73 using glycerol as starter with approx. 83 mole % primary OH groups.
A2-3: BIOH® 5000, soybean oil-based polyol, hydroxyl value 50.5 mg KOH/g, manufacturer Cargill GmbH, Hamburg, Germany.
A4-1 Tegostab® B 8681, preparation of organo-modified polysiloxanes, Evonik Goldschmidt
A4-2 Addocat® 105, amine catalyst from Rheinchemie
A4-3 Addocat® 108, amine catalyst from Rheinchemie
A4-4 Addocat® SO, tin catalyst from Rheinchemie
A4-5 Tegostab® B 8715LF, preparation of organo-modified polysiloxanes, Evonik Goldschmidt
A4-6 Dabco® NE300, amine catalyst from Air Products.
A4-7 Jeffcat® ZR50, amine catalyst from Huntsman Corp. Europe.
A5-1 Diethanolamine

The analyses were carried out as follows:

Dynamic viscosity: MCR 51 rheometer from Anton Paar corresponding to DIN 53019.
Hydroxyl value: based on the standard DIN 53240
Acid value: based on the standard DIN 53402

The bulk density was determined according to DIN EN ISO 3386-1-98.

The compressive strength was determined according to DIN EN ISO 3386-1-98 (at 40% deformation and 4th cycle).

The compressive sets DVR 50% (Ct) and DVR 75% (Ct) were determined according to DIN EN ISO 1856-2001-03 at 50% and 75% deformation respectively.

The tensile strength and elongation at break were determined according to DIN EN ISO 1798.

Production of the polyricinolate A2-1:

In a 16000-litre stirrer vessel with distillation columns and an attached partial condenser, 13000 kg ricinoleic acid and 650 kg hexanediol were taken in and heated to 200° C. with stirring. During the heating phase, water of reaction was distilled off under standard pressure. When the reaction temperature was reached, a vacuum was applied. The pressure was reduced to 20 mbar within one hour. Meanwhile, the head temperature was maintained at the level of the water boiling line by means of controlling the partial condenser temperature. At a pressure of 200 mbar after 3.5 hours, 320 g of a 28% solution of tin dichloride (anhydrous) in ethylene glycol were added. At the same time the partial condenser temperature was fixed at 60° C. In the course of the further reaction, the acid value was monitored: the acid value after a total reaction period of 24 hours was 10 mg KOH/g, after 48 hours 5 mg KOH/g, after 72 hours 3.5 mg KOH/g and after 84 hours 3.0 mg KOH/g. After a reaction period of 84 hours, the reactor contents were cooled to 130° C.

Analysis of the resulting polyricinolate A2-1:

Hydroxyl value: 37.5 mg KOH/g
Acid value: 3.0 mg KOH/g
Viscosity: 850 mPas (25° C.)
Catalyst concentration: 4 ppm Sn in the end product

Production of the polyricinolate A2-2:

In a 10-litre four-neck flask, equipped with a mechanical stirrer, 50 cm Vigreux column, thermometer, nitrogen feed and column head, distillation bridge and vacuum membrane pump, 7775 g ricinoleic acid (approx. 24 mol) and 657 g (5.57 mol) 1,6-hexanediol were initially charged and heated to 200° C. under nitrogen blanketing in the course of 60 min, with water of reaction being distilled off. After 8 hours, 480 mg tin dichloride dihydrate were added and the reaction was continued. After a reaction period of a total of 17 hours, the pressure was reduced slowly over 5 hours to 15 mbar. In the course of the further reaction, the acid value was monitored: after a reaction period of a total of 45 hours, the acid value was 7.5 mg KOH/g, after 76 hours 3.0 mg KOH/g and after 100 hours 2.9 mg KOH/g.

Analysis of the resulting polyricinolate A2-2:

Hydroxyl value: 53.3 mg KOH/g
Acid value: 2.9 mg KOH/g
Viscosity: 325 mPas (25° C.) or 100 mPas (50° C.) or 45 mPas (75° C.)
Catalyst concentration: 4 ppm Sn in the end product

### B) Production of Flexible Polyurethane Slabstock Foams

In a processing method conventional for the production of polyurethane foams, the feed materials listed in the examples in the following table 1 are reacted with one another by the one-step method.

TABLE 1
Production and evaluation of flexible polyurethane slabstock foams

| | | 1 | 2 | 3 | 4 | 5 | 6 | | | | | | 12 | |
|---|---|---|---|---|---|---|---|---|---|---|---|---|---|---|
| | | (Cp.) | (Cp.) | (Cp.) | (Cp.) | (Cp.) | (Cp.) | 7 | 8 | 9 | 10 | 11 | (Cp.) | 13 |
| A1-1 | [pts. by wt.] | 92.45 | 87.58 | 82.72 | 77.85 | 48.66 | 97.31 | 92.45 | 87.58 | 82.72 | 77.85 | 48.66 | 29.19 | 77.85 |
| A2-3 | [pts. by wt.] | 4.87 | 9.73 | 14.60 | 19.46 | 48.66 | 0.00 | | | | | | | |
| A2-2 | [pts. by wt.] | | | | | | | 4.87 | 9.73 | 14.60 | 19.46 | 48.66 | 68.12 | |
| A2-1 | [pts. by wt.] | | | | | | | | | | | | | 19.46 |
| Water | [pts. by wt.] | 2.24 | 2.24 | 2.24 | 2.24 | 2.24 | 2.24 | 2.24 | 2.24 | 2.24 | 2.24 | 2.24 | 2.24 | 2.24 |
| A4-1 | [pts. by wt.] | 0.10 | 0.10 | 0.10 | 0.10 | 0.10 | 0.10 | 0.10 | 0.10 | 0.10 | 0.10 | 0.10 | 0.10 | 0.10 |
| A4-2 | [pts. by wt.] | 0.16 | 0.16 | 0.16 | 0.16 | 0.16 | 0.16 | 0.16 | 0.16 | 0.16 | 0.16 | 0.16 | 0.16 | 0.16 |
| A4-3 | [pts. by wt.] | 0.15 | 0.15 | 0.15 | 0.15 | 0.15 | 0.15 | 0.15 | 0.15 | 0.15 | 0.15 | 0.15 | 0.15 | 0.15 |
| A4-4 | [pts. by wt.] | 0.05 | 0.05 | 0.05 | 0.05 | 0.05 | 0.05 | 0.05 | 0.05 | 0.05 | 0.05 | 0.05 | 0.05 | 0.05 |
| MDI-1 | [MV] | 35.04 | 35.27 | 35.49 | 35.72 | 37.09 | 34.81 | 35.07 | 35.32 | 35.58 | 35.84 | 37.38 | 38.40 | 38.40 |
| Index | | 90 | 90 | 90 | 90 | 90 | 90 | 90 | 90 | 90 | 90 | 90 | 90 | 90 |
| Cream time | [s] | 12 | 12 | 14 | 11 | 11 | 12 | 12 | 12 | 12 | 12 | 20 | 20 | 10 |
| Rise time | [s] | 127 | 125 | 121 | 112 | | 115 | 120 | 120 | 125 | 125 | 130 | | 120 |
| Bulk density | [kg/m³] | 60.2 | 62 | 64.6 | 64.5 | coll. | 54.4 | 55.2 | 56.7 | 57.1 | 58.4 | 66.1 | coll. | |
| Tensile | [kPa] | 59 | 73 | 74 | 78 | | 48 | 68 | 61 | 73 | 70 | 94 | | |
| strength | | | | | | | | | | | | | | |
| Elongation | [%] | 108 | 115 | 111 | 106 | | 95 | 111 | 104 | 112 | 116 | 95 | | |
| at break | | | | | | | | | | | | | | |
| Compressive | [kPa] | 3.92 | 4.71 | 4.32 | 4.98 | | 3.57 | 3.8 | 3.99 | 3.54 | 3.78 | 5.2 | | |
| strength | | | | | | | | | | | | | | |

Abbreviations:
Cp. = comparative example;
coll. = collapse;
pts. by wt. = parts by weight;
MV = weight ratio of component A to component B at given index and based on 100 parts by weight of component A.

The flexible polyurethane slabstock foams according to the invention (examples 7 to 11 and 13) in which polyricinoleic acid esters according to component A2 were processed could be produced with an otherwise unchanged formulation compared with the flexible foam based on purely conventional polyol A1-1 (comparative example 6), i.e. in terms of processing, compressive strength and tensile properties of the resulting flexible slabstock foams there were no substantial differences over comparative example 6.

### C) Production of Flexible Polyurethane Moulded Foams

In a processing method conventional for the production of flexible polyurethane moulded foams, the feed materials listed in the examples in the following table 1 are reacted with one another by the one-step method. The reaction mixture is introduced into a mould having a volume of 10 l heated to 60 or 75° C. and is demoulded after 5 min. The feed quantity of the raw materials was selected so that a calculated moulding density of about 55 kg/m³ results. Shown in table 2 is the moulding density actually obtained, which was determined in accordance with DIN EN ISO 3386-1-98.

TABLE 2
Production and evaluation of flexible polyurethane moulded foams

| | | 14 | 15 | 16 |
|---|---|---|---|---|
| A1-1 | [pts. by wt.] | 91.77 | 82.31 | 83.57 |
| A1-2 | [pts. by wt.] | 2.84 | 2.84 | 1.42 |
| A2-1 | [pts. by wt.] | 0.00 | 9.46 | 0.00 |
| A2-3 | [pts. by wt.] | 0.00 | 0.00 | 9.44 |
| Water | [pts. by wt.] | 3.03 | 3.03 | 3.02 |
| A4-5 | [pts. by wt.] | 0.95 | 0.95 | 0.94 |
| A4-6 | [pts. by wt.] | 0.09 | 0.09 | 0.09 |
| A4-7 | [pts. by wt.] | 0.38 | 0.38 | 0.38 |
| A5-1 | [pts. by wt.] | 0.95 | 0.95 | 1.13 |
| MDI-2 | [MV] | 53.2 | 53.2 | 53.8 |
| Index | | 95 | 95 | 95 |
| Mould temperature | ° C. | 60 | 75 | 75 |
| Demoulding time | min | 5 | 5 | 5 |
| Compressive strength | kPa | 7.58 | 7.14 | 7.47 |
| Bulk density | kg/m³ | 53.3 | 55.6 | 54.4 |
| Tensile strength | kPa | 133 | 114 | 118 |
| Elongation at break | % | 93 | 92 | 87 |
| DVR 50% | Ct(%) | 5.4 | 5.4 | 5.4 |
| DVR 70% | Ct(%) | 6.5 | 6.8 | 8.1 |

Abbreviations: Cp. = comparative example; pts. by wt. = parts by weight; MV = weight ratio of component A to component B at given index and based on 100 parts by weight of component A.

The flexible polyurethane moulded foam (example 15) in which polyricinoleic acid ester according to component A2-1 was processed could be produced with an otherwise unchanged formulation compared with the flexible foam based on purely conventional polyol A1-1 (comparative example 14), i.e. in terms of processing and properties of the resulting flexible moulded foams there were no substantial differences over comparative example 14. On the other hand, for the processing of a polyol A2-3 based on sustainable raw material which was not according to the invention, the formulation had to be adapted by counteracting component A2-3, which had a destabilising effect during processing, by reducing the proportion of polyol A1-2 which had a cell-opening action and increasing component A5-1 which had a crosslinking action.

1. A method for producing flexible polyurethane foams with a bulk density according to DIN EN ISO 3386-1-98 in the range of ≧10 kg/m³ to ≦150 kg/m³ and a compressive strength according to DIN EN ISO 3386-1-98 in the range of ≧0.5 kPa to ≦20 kPa (at 40% deformation and 4th cycle) by reaction of component A comprising
A1 50 to 95 parts by weight (based on the sum of the parts by weight of components A1 and A2) of conventional polyether polyol,
A2 5 to 50 parts by weight (based on the sum of the parts by weight of components A1 and A2) of polyricinoleic acid ester with a hydroxyl value of 30 mg KOH/g to 80 mg KOH/g and an acid value of less than 5 mg KOH/g,
A3 0.5 to 25 parts by weight (based on the sum of the parts by weight of components A1 and A2) of water and/or physical blowing agents,
A4 0.05 to 10 parts by weight (based on the sum of the parts by weight of components A1 and A2) of auxiliary substances and additives such as
d) catalysts,
e) surface-active additives,
f) pigments or flame retardants,
with component B comprising polyisocyanates,
wherein the production takes place at an index of 50 to 250, and wherein all data relating to parts by weight of components A1 to A5 in the present application are standardised so that the sum of the parts by weight of components A1+A2 in the composition is 100.

2. The method according to claim 1, wherein component A can additionally comprise
A5 0 to 10 parts by weight (based on the sum of the parts by weight of components A1 and A2) of compounds having hydrogen atoms capable of reacting with isocyanates having a molecular weight of 62-399.

3. The method according to claim 1 or 2, wherein one or more alkylene oxide addition products of starter compounds with Zerewitinoff active hydrogen atoms are used as the conventional polyether polyol.

4. The method according to claim 1 or 2, wherein one or more alkylene oxide addition products obtainable by reaction of at least one starter compound selected from the group consisting of propylene glycol, ethylene glycol, diethylene glycol, dipropylene glycol, 1,2-butanediol, 1,3-butanediol, 1,4-butanediol, hexanediol, pentanediol, 3-methyl-1,5-pentanediol, 1,12-dodecanediol, glycerol, trimethylolpropane, triethanolamine, pentaerythritol, sorbitol, sucrose, hydroquinone, pyrocatechol, resorcinol, bisphenol F, bisphenol A, 1,3,5-trihydroxybenzene and condensates of formaldehyde and phenol comprising methylol groups, condensates of formaldehyde and melamine comprising methylol groups and condensates of formaldehyde and urea comprising methylol groups, with
at least one alkylene oxide selected from the group consisting of ethylene oxide, propylene oxide, 1,2-butylene oxide, 2,3-butylene oxide and styrene oxide are used as the conventional polyether polyol.

5. The method according to one of claims 1 to 4, wherein the polyricinoleic acid ester is obtainable by polycondensation of ricinoleic acid and mono- or polyhydric alcohols.

6. The method according to claim 5, wherein the polyricinoleic acid ester is obtainable by polycondensation of monomeric ricinoleic acid and mono- or polyhydric alcohols in the presence of at least one catalyst selected from the group consisting of sulfuric acid, p-toluenesulfonic acid, tin(II) salts and titanium(IV) compounds.

7. The method according to claim 5 or 6, wherein the mono- or polyhydric alcohols are selected from at least one from the group consisting of n-hexanol, n-dodecanol, n-octadecanol, cyclohexanol, 1,4-dihydroxycyclohexane, 1,3-propanediol, 2-methyl-1,3-propanediol, 1,5-pentanediol, 1,6-hexanediol, 1,8-octanediol, neopentyl glycol, diethylene glycol, triethylene glycol, tetraethylene glycol, dipropylene glycol, tripropylene glycol, dibutylene glycol, tripropylene glycol, glycerol and trimethylolpropane.

8. The method according to one of claims 5 to 7, wherein the polyricinoleic acid ester is obtainable by polycondensation of ricinoleic acid and the alcohol component without catalyst at a temperature of ≧150° C. to ≦250° C., preferably ≧180° C. to ≦230° C. and particularly preferably ≧190° C. to ≦210° C. until the water formation reaction has come to a stop, subsequent addition of the catalyst and further polycondensation at a temperature of ≧150° C. to ≦250° C., preferably ≧180° C. to ≦230° C. and particularly preferably ≧190° C. to ≦210° C., and distilling off the resulting water until the acid value of the reaction mixture (polyricinoleic acid ester) is less than 5 mg KOH/g.

9. The method according to one of claims 1 to 8, wherein the polyricinoleic acid ester has an acid value of less than 4 mg KOH/g.

10. The method according to one of claims 1 to 9, wherein the production takes place at an index of 75 to 115.

11. The method according to one of claims 1 to 10, wherein at least one compound selected from the group consisting of 2,4-toluene diisocyanate, 2,6-toluene diisocyanate, 4,4′-diphenylmethane diisocyanate, 2,4′-diphenylmethane diisocyanate, 2,2′-diphenylmethane diisocyanate and polyphenyl polymethylene polyisocyanate is used as component B.

12. Flexible polyurethane foams with a bulk density according to DIN EN ISO 3386-1-98 in the range of ≧10 kg/m³ to ≦150 kg/m³ and a compressive strength according to DIN EN ISO 3386-1-98 in the range of ≧0.5 kPa to ≦20 kPa (at 40% deformation and 4th cycle) obtainable by a method according to one of claims 1 to 11.

13. Use of polyricinoleic acid ester with a hydroxyl value of 30 mg KOH/g to 80 mg KOH/g and an acid value of less than 5 mg KOH/g for the production of flexible polyurethane foams with a bulk density according to DIN EN ISO 3386-1-98 in the range of ≧10 kg/m³ to ≦150 kg/m³ and a compressive strength according to DIN EN ISO 3386-1-98 in the range of ≧0.5 kPa to ≦20 kPa (at 40% deformation and 4th cycle).
